(19) United States
(12) Patent Application Publication
(10) Pub. No.: US 2026/0052581 A1
(43) Pub. Date: Feb. 19, 2026

(54) BASE STATION APPARATUS, TERMINAL APPARATUS, CONTROL METHOD, AND COMPUTER-READABLE STORAGE MEDIUM FOR ESTABLISHING EFFICIENT CONNECTION

(71) Applicant: KDDI CORPORATION, Tokyo (JP)

(72) Inventors: Takehiro HOSHIKAWA, Tokyo (JP); Toshiaki YAMAMOTO, Tokyo (JP)

(21) Appl. No.: 19/323,727

(22) Filed: Sep. 9, 2025

Related U.S. Application Data
(63) Continuation of application No. PCT/JP2024/003680, filed on Feb. 5, 2024.

(30) Foreign Application Priority Data
Mar. 15, 2023 (JP) 2023-040613

(51) Int. Cl. H04W 74/0833; H04B 7/06

(52) U.S. Cl. CPC H04W 74/0833; H04B 7/06952

(57) ABSTRACT

A base station apparatus that forms a plurality of beams notifies a terminal apparatus of information indicating radio resources to be used in transmission of a random access preamble by the terminal apparatus for each of the plurality of beams and information of a predetermined sequence of a random access preamble allowed for transmission using any of the radio resources of the plurality of beams, and establishes, in a case where a random access preamble generated using the predetermined sequence is detected using the radio resource corresponding to one beam included in the plurality of beams, a connection with the terminal apparatus that transmitted the random access preamble.

### CROSS-REFERENCE TO RELATED APPLICATION(S)

This application is a continuation of International Patent Application No. PCT/JP2024/003680 filed on Feb. 5, 2024, which claims priority to and the benefit of Japanese Patent Application No. 2023-040613 filed on Mar. 15, 2023, the entire disclosures of which are incorporated herein by reference.

### BACKGROUND OF THE INVENTION

### Field of the Invention

The present invention relates to technology for increasing the network connection speed of a terminal apparatus.

### Description of the Related Art

In the fifth generation (5G) cellular communication standards of the 3rd Generation Partnership Project (3GPP), to expand the area at high-frequency bands, it is specified to form a plurality of beams to increase the gain for a certain direction in the base station apparatus and use beamforming to perform communication per beam. Narrower beam widths give increased gain for a specific direction. Thus, a terminal apparatus farther away from the base station apparatus can communicate with the base station apparatus. Note that when the beam width is narrow, the area in which communication is possible in a radial direction centered on the base station apparatus is expanded, but the area in which communication is possible in the circumferential direction is narrowed. Thus, to provide area coverage, multiple beams need to be set.

A terminal apparatus observes a synchronization signal/physical broadcast channel block (SS/PBCH block, referred to below as SSB) transmitted within a certain time period in each beam and selects a suitable beam for communication (see 3GPP TS38.213, V17.0.0, December 2021). Also, for example, in a case where the terminal apparatus is notified by a base station apparatus that data addressed to it exists or a case where data to be transmitted to it is generated, the terminal apparatus connects to the network via the selected beam and performs communication. When connecting to the network, the terminal apparatus transmits a random-access channel (RACH) using predetermined radio resources (time and frequency resources). However, when the number of beams is increased, the time period for arrival of the predetermined radio resources for transmitting a RACH is increased in time, and the amount of time it takes for the terminal apparatus to connect to the beam is increased.

### SUMMARY OF THE INVENTION

The present invention provides technology for reducing the amount of time take for a terminal apparatus to connect to a network.

A base station apparatus according to one aspect of the present invention comprises: a forming unit configured to form a plurality of beams; a notifying unit configured to notify a terminal apparatus of information indicating radio resources to be used in transmission of a random access preamble by the terminal apparatus for each of the plurality of beams and information of a predetermined sequence of a random access preamble allowed for transmission using any of the radio resources of the plurality of beams; and an establishing unit configured to, in a case where a random access preamble generated using the predetermined sequence is detected using the radio resource corresponding to one beam included in the plurality of beams, establish a connection with the terminal apparatus that transmitted the random access preamble.

A terminal apparatus according to one aspect of the present invention comprises: a receiving unit configured to receive, from a base station apparatus, information indicating radio resources to be used in transmission of a random access preamble by the terminal apparatus for each of a plurality of beams formed by the base station apparatus and information of a predetermined sequence of a random access preamble allowed for transmission using any of the radio resources of the plurality of beams; and an establishing unit configured to transmit a random access preamble generated using the predetermined sequence using the radio resource corresponding to any of the plurality of beams to attempt to establish a connection with the base station apparatus.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating an example of the configuration of a wireless communication system;

FIG. 2 is a diagram for describing a method for determining a sequence of a preamble that can be commonly used by a plurality of beams;

FIG. 3 is a diagram illustrating an example of the hardware configuration of an apparatus;

FIG. 4 is a diagram illustrating an example of the functional configuration of a base station apparatus;

FIG. 5 is a diagram illustrating an example of the functional configuration of a terminal apparatus;

FIG. 6 is a diagram illustrating an example of the flow of the processing executed by the base station apparatus; and

FIG. 7 is a diagram illustrating an example of the flow of the processing executed by the terminal apparatus.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Wireless Communication System

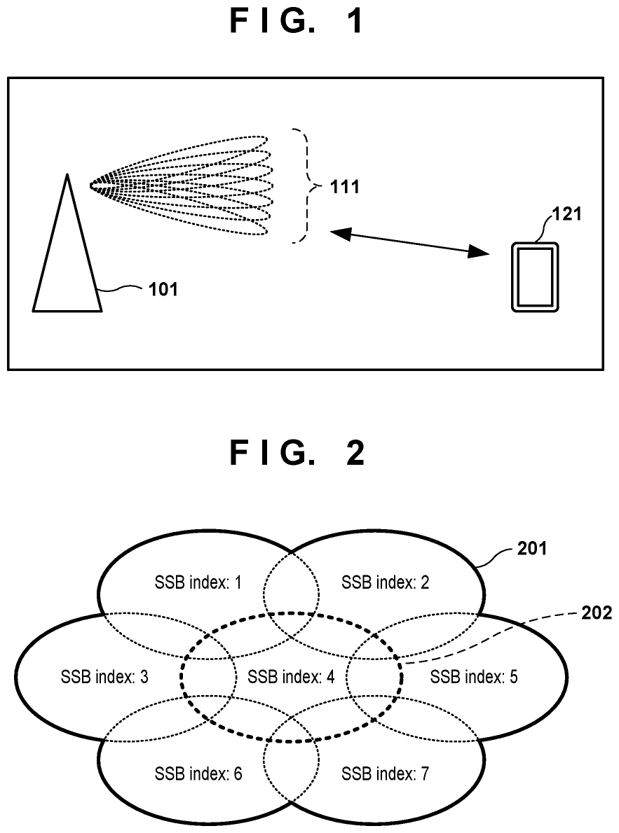

FIG. 1 illustrates an example configuration of a wireless communication system according to the present embodiment. The present wireless communication system is, for example, a cellular communication system configured to be compliant with a cellular communication standard such as the 5th generation (5G) of the 3rd Generation Partnership Project (3GPP (registered trademark)) and the like. The wireless communication system includes a base station apparatus 101 and a terminal apparatus 121. Note that in FIG. 1, only one base station apparatuses and one terminal apparatus are illustrated to simplify the description, but naturally multiple base station apparatuses and multiple terminal apparatuses may exist. The base station apparatus 101 includes multiple antennas, for example, and is configured to be able to form a plurality of beams 111 with the gain for the different directions increase by adjusting the antenna weighting. The terminal apparatus 121 can connect to a network (the base station apparatus 101) via one of the beams of the plurality of beams 111.

When the terminal apparatus 121 connects to the base station apparatus 101, the terminal apparatus 121 receives a synchronization signal/physical broadcast channel (SS/PBCH) block (SSB) broadcast from the base station apparatus 101 per beam. Note that a maximum of two SSBs may be disposed per one time slot. In other words, in a case where multiple beams are formed, SSBs of a maximum of two beams are transmitted per one time slot. The terminal apparatus 121 can observe the SSB, decode the SSB of a beam with good wireless quality, and obtain system information. Also, the terminal apparatus 121 receives the system information and executes a random-access process. In the random-access process, the terminal apparatus 121 transmits a random access preamble using a predetermined radio resource (frequency and time resource) specified by the system information. Specifically, the terminal apparatus 121 transmits a random access preamble so that the random access preamble reaches the base station apparatus 101 using the radio resource set by the base station apparatus 101. The radio resource to use for transmitting and receiving the random access preamble is set per beam. Here, the radio resources corresponding to the plurality of beams are set so as to not overlap with one another. However, if the number of beams is increased, since the radio resources are set so as to not overlap with one another, even when the radio resources differing in the frequency direction are set, for example, the time period for radio resources corresponding to each beam to be generated may increase in time. As a result, when the terminal apparatus 121 tries to connect to a beam with good wireless quality, the time until the arrival of a radio resource that can transmit a random access preamble on the beam is increased, leading to inefficiency.

In the present embodiment, in light of these circumstances, a sequence of random access preambles that can be commonly used by the plurality of beams is set. Also, the terminal apparatus 121 is configured to transmit a random access preamble generated using the commonly used sequence using the radio resource corresponding to one of the beams of the plurality of beams. For example, the seven areas indicated by SSB index=1 to 7 in FIG. 2 are covered by seven of the beams. At this time, a predetermined sequence of a random access preamble that can be commonly used for an entire area 201 is set. Then, the terminal apparatus 121 may generate and transmit a random access preamble using the predetermined sequence using any one of SSB index=1 to 7. In other words, the terminal apparatus 121 is configured to permit a random access preamble generated using a predetermined sequence to be transmitted using a radio resource for random access preamble transmission on a beam of an SSB index=2 to 7 while in an area corresponding to a beam of an SSB index=1. Accordingly, the terminal apparatus 121 existing in an area corresponding to a beam of an SSB index=1 is configured to be able to transmit a random access preamble using not only the radio resource for SSB index=1 but also radio resources for SSB index=2 to 7. In other words, compared to a case where a random access preamble can only be transmitted using a radio resource corresponding to a beam of an SSB index=1, there are a greater number of opportunities to transmit a random access preamble. Also, for example, in a case where the terminal apparatus 121 has established a connection with the base station apparatus 101 via a beam of an SSB index=2 to 4 or the like, the terminal apparatus 121 can swiftly communicate with the base station apparatus 101. In other words, the terminal apparatus 121 can attempt to establish a connection even with a beam of relatively low wireless quality and start communication of user data if the connection is established. In this manner, the terminal apparatus 121 can greatly reduce the amount of time it takes for the terminal apparatus 121 to start communicating user data.

Note that, for example, the base station apparatus 101 notifies the terminal apparatus 121 of information of the predetermined sequence of a random access preamble allowed for transmission using any of the radio resources for transmission of a random access preamble corresponding to the plurality of beams formed by the base station apparatus 101. Also, the base station apparatus 101 notifies the terminal apparatus 121 of information indicating the radio resource to be used in the transmission of a random access preamble for each of the plurality of beams. Accordingly, the terminal apparatus 121 can recognize the radio resource for transmission of a random access preamble corresponding to each of the plurality of beams formed by the base station apparatus 101 and the predetermined sequence able to be commonly used for the plurality of beams. In this manner, as described above, the terminal apparatus 121 can transmit a random access preamble using a radio resource corresponding to each of the plurality of beams.

Note that instead of a predetermined sequence commonly used for each of the plurality of beams, a sequence may be individually allocated to each beam. Accordingly, a terminal apparatus which needs to reduce the amount of time taken for connection to be established can use the commonly used predetermined sequence, and a terminal apparatus without such time constraints can attempt to establish a connection using a sequence specific a beam using a radio resource of the specific beam, as typically performed. In other words, the terminal apparatus can measure the wireless signal from each beam, select one beam with good wireless quality, and generate and transmit a random access preamble using a sequence specific to the one beam using a radio resource corresponding to the one beam. Accordingly, for example, a terminal apparatus requesting good wireless quality over a reduction in the amount of time taken for connection to be established can select a beam with good wireless quality and establish a connection.

Note that the predetermined sequence may be selected from among the individual sequences of the plurality of beams. For example, a sequence of a random access preamble that can be used for a predetermined beam (for example, a beam of SSB index=1) from among the beams of SSB index=1 to 7 may be used as the predetermined sequence. For example, in a case where there is a tendency for the terminal apparatus to be biased toward existing in a predetermined range of the entire area 201 including the areas corresponding to the plurality of beams, a beam corresponding to an area included in the predetermined range may be set as the predetermined beam described above. Also, in a case where there is a tendency for the terminal apparatus to be biased toward existing in a predetermined range of the entire area 201 including the areas corresponding to the plurality of beams, a beam corresponding to an area not included in the predetermined range may be set as the predetermined beam described above. Also, a beam covering an area corresponding the center of the entire area 201 may be set as the predetermined beam described above. Also, for example, if a center point of an area covered by a beam i is defined as a vector xi, a beam j with the smallest value for Σ|xi−xj| may be selected as the predetermined beam. In other words, the beam with the smallest value for the sum (or average) of the distances from the center of the area covered by other beams may be selected as the predetermined beam.

In the example of FIG. 2, a sequence allocated to a beam of SSB index=4 covering an area 202 including the center of the entire area 201 may be set as the predetermined sequence commonly used by the plurality of beams. Also, for example, when the base station apparatus 101 receives a random access preamble generated using this sequence, the base station apparatus 101 may establish a connection with the terminal apparatus assuming that the terminal apparatus exists in an area corresponding to a beam of an SSB index=4. When such processing is executed, in a case where the sequence allocated to a beam of an SSB index=7 is set as the predetermined sequence commonly used by the plurality of beams and the terminal apparatus exists in an area corresponding to a beam of an SSB index=1, the base station apparatus 101 may attempt to establish a connection with the terminal apparatus via a beam of an SSB index=7. In this case, for the terminal apparatus, a beam of an SSB index=7 may have low gain and low wireless quality. However, in a case where a sequence allocated to a beam of an SSB index=4 is set as the predetermined sequence commonly used by the plurality of beams, reduction of beam gain is reduced regardless of the position in the entire area 201. Thus, a terminal apparatus within the range of the entire area 201 can communicate with a constant wireless quality.

As described above, the terminal apparatus 121 generates a random access preamble using the predetermined sequence commonly used for the plurality of beams and transmits the random access preamble using a radio resource corresponding to any of the plurality of beams. Using such a method, take an example in which the terminal apparatus 121 transmits a random access preamble using a radio resource corresponding to a beam with low gain at the position of the terminal apparatus 121. In this example, the terminal apparatus 121 cannot establish a connection with the base station apparatus 101. Accordingly, when the terminal apparatus 121 fails in its attempt to establish a connection with the base station apparatus 101 consecutively for a predetermined number of times, the terminal apparatus 121 may perform a typical random-access process. In other words, in a case where the result of the terminal apparatus 121 transmitting a random access preamble using the predetermined sequence commonly used by the plurality of beams is being unable to establish a connection consecutively for a predetermined number of times, the terminal apparatus 121 selects one beam with a good beam measurement result. Then, the terminal apparatus 121 generates a random access preamble using the sequence specific to the beam and transmits the random access preamble using the radio resource corresponding to the beam. In other words, in this example, the terminal apparatus 121 does not use the radio resource for the random access preamble for other beams. Accordingly, in a case where the random-access process using the commonly used sequence has repeatedly failed, the terminal apparatus 121 performs a typical random-access process and reliably establishes a connection with the base station apparatus 101 via a beam with good wireless quality.

### Apparatus Configuration

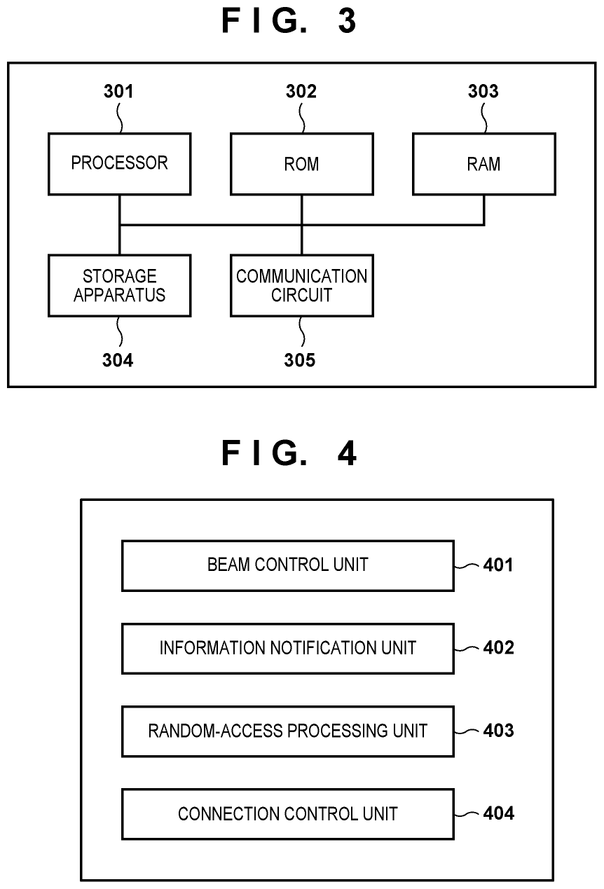

Next, the apparatus configuration will be described. FIG. 3 illustrates an example of the hardware configuration of the base station apparatus and the terminal apparatus according to the present embodiment. The base station apparatus and the terminal apparatus, for example, include a processor 301, a ROM 302, a RAM 303, a storage apparatus 304, and a communication circuit 305. The processor 301 is a computer, such as a general-purpose central processing unit (CPU), an application specific integrated circuit (ASIC), or the like, including one or more processing circuits. By the processor 301 reading out and executing a program stored in the ROM 302 and the storage apparatus 304, the processing of the entire apparatus and the processing described above are executed. The ROM 302 is read-only memory that stores information, such as a program relating to processing executed by the base station apparatus and the terminal apparatus, various parameters, and the like. The RAM 303 is random-access memory that functions as a work space when the processor 301 executes a program and temporary stores information. The storage apparatus 304 is constituted by a detachable external storage device, for example. The communication circuit 305 is constituted by a circuit for LTE or 5G wireless communication, for example. Note that in FIG. 3, only the single communication circuit 305 is illustrated, but the base station apparatus and the terminal apparatus may include a plurality of communication circuits. For example, the base station apparatus and the terminal apparatus may include a wireless communication circuit for LTE, 5G, and for successive standards and an antenna shared by the circuits. Note that the base station apparatus and the terminal apparatus may separately include an antenna appropriate for each standard. Also, the base station apparatus may further include a wired communication circuit used when communicating with another base station apparatus or a core network node. Also, the terminal apparatus may further include a communication circuit or the like compliant with a wireless communication standard other than cellular communication standards such as wireless local area network (LAN) and Bluetooth (registered trademark). Note that the base station apparatus and the terminal apparatus may include separate communication circuits 305 for a plurality of usable frequency bands or may include common communication circuits 305 shared by two or more of the frequency bands.

FIG. 4 is a diagram illustrating an example of the functional configuration of the base station apparatus. The base station apparatus includes, for example, a beam control unit 401, an information notification unit 402, a random-access processing unit 403, and a connection control unit 404. Note that in FIG. 4, only the functions relating specifically to the present embodiment are illustrated, and various other functions that the base station apparatus may include are omitted from the diagram. For example, the base station apparatus naturally includes other functions typically included in a base station apparatus that uses LTE, 5G, or the like. Also, the functional blocks in FIG. 4 are schematically illustrated, and the functional blocks may be integrally formed or may be subdivided when implemented. Also, the functions in FIG. 4 may be implemented by the processor 301 executing a program stored in the ROM 302 or the storage apparatus 304 or may be implemented by a processor inside the communication circuit 305 executing a predetermined piece of software, for example. Note that the processing executed by the functional units described above will not be described here, and the functions will be described here in broad terms.

The beam control unit 401 forms the plurality of beams that can be formed by the base station apparatus.

For the plurality of beams formed in the beam control unit 401, the information notification unit 402 sets the radio resources to be used in the transmission of a random access preamble by the terminal apparatus and a predetermined sequence of a random access preamble allowed for transmission using any of the radio resources of the plurality of beams. Note that the information notification unit 402 may, for each beam, set a sequence allowed for transmission using only each radio resource for a random access preamble of the plurality of beams instead of using the predetermined sequence. In other words, the information notification unit 402 may set the sequence for a random access preamble specific to each one of the plurality of beams. Also, the information notification unit 402 may set a sequence set for a random access preamble specific to a specific beam from among the plurality of beams as the predetermined sequence of a random access preamble allowed for transmission using any of the radio resources of each of the plurality of beams. In other words, one or more or all of the sequences for a random access preamble for the specific beam may be set so that transmission is also allowed using the radio resources of other beams. Note that the plurality of beams commonly used by the predetermined sequence may be all of the beams that are formable in the base station apparatus or may be one or more of the formable beams. Also, the information notification unit 402 notifies the terminal apparatus of the set information. In other words, for the plurality of beams, the terminal apparatus is notified of the radio resources to be used in the transmission of a random access preamble by the terminal apparatus and a predetermined sequence of a random access preamble allowed for transmission using any of the radio resources of the plurality of beams. The information notification unit 402 also notifies the terminal apparatus of the information of the sequence specific to each beam. Note that the information notification unit 402 may broadcast the setting information described above using a system information block (SIB), for example.

The random-access processing unit 403 detects the random access preamble transmitted from the terminal apparatus. Then, the connection control unit 404 performs a random-access process with the terminal apparatus which is the transmission source of the random access preamble and establishes a connection with the terminal apparatus. The connection control unit 404, on the basis of the radio resource used to receive the random access preamble in the random-access processing unit 403, processing to connect to the terminal apparatus which is the random access preamble transmission source is executed using the beam corresponding to the radio resource. Note that in a case where the sequence allocated to the one specific beam from among the plurality of beams is set as the predetermined sequence allowed to be transmitted also using any radio resource corresponding to each of the plurality of beams, the connection control unit 404 may use the specific beam to execute processing to connect to the terminal apparatus which is the random access preamble transmission source. In other words, in a case where the sequence corresponding to the specific beam is treated as the predetermined sequence allowed to be transmitted using radio resource for random access preamble of the plurality of beams, the connection control unit 404 may attempt to establish a connection using the specific beam regardless of the radio resource used to receive the random access preamble. For example, in a case where, from among the plurality of beams, the beam with the smallest sum of distances from the center of the coverage area to the center of areas covered by other beams is selected as the specific beam, such processing may be executed. Note that this is an example, and even in a case where a sequence corresponding to the specific beam is treated as the predetermined sequence, the connection control unit 404 may attempt to establish a connection using the beam corresponding to the radio resource used to receive the random access preamble. Also, in a case where a predetermined sequence is prepared separate to a sequence specific to each of the plurality of beams, the connection control unit 404 may attempt to establish a connection using the beam corresponding to the radio resource used to receive the random access preamble.

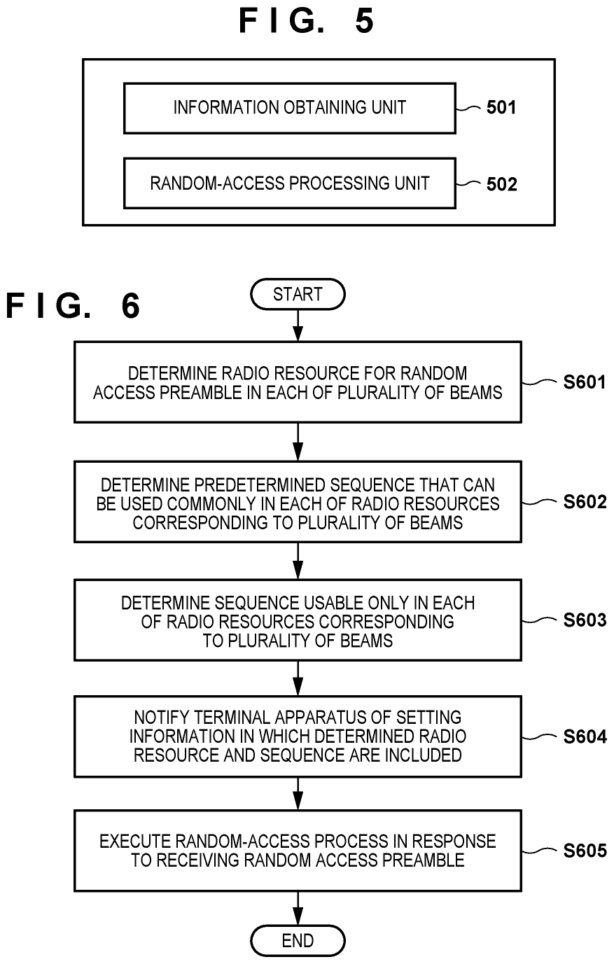

FIG. 5 illustrated an example of the functional configuration of the terminal apparatus. The terminal apparatus, for example, includes an information obtaining unit 501 and a random-access processing unit 502. Note that in FIG. 5, only the functions relating specifically to the present embodiment are illustrated, and various other functions that a terminal apparatus may include are omitted from the diagram. For example, the terminal apparatus naturally includes other functions typically included in a terminal apparatus that uses LTE, 5G, or the like. Also, the functional blocks in FIG. 5 are schematically illustrated, and the functional blocks may be integrally formed or may be subdivided when implemented. Also, the functions in FIG. 5 may be implemented by the processor 301 executing a program stored in the ROM 302 or the storage apparatus 304 or may be implemented by a processor inside the communication circuit 305 executing a predetermined piece of software, for example. Note that the processing executed by the functional units described above will not be described here, and the functions will be described here in broad terms.

For the plurality of beams formed by the base station apparatus, the information obtaining unit 501 receives, from the base station apparatus, setting information including information of the radio resources to be used in the transmission of a random access preamble by the terminal apparatus and information of a predetermined sequence of a random access preamble allowed for transmission using any of the radio resources of the plurality of beams. The setting information may include information indicating a sequence allowed for transmission using only each radio resource for a random access preamble of the plurality of beams instead of using the predetermined sequence described above.

The random-access processing unit 502, on the basis of the information obtained by the information obtaining unit 501, transmits a random access preamble and attempts to establish a connection with the base station apparatus. For example, the random-access processing unit 502 generates a random access preamble using the predetermined sequence described above and transmits the generated random access preamble using the radio resource corresponding to the earliest timing from among the radio resources corresponding to the plurality of beams. Thereafter, in a case where a random access response is received from the base station apparatus using any of the plurality of beams, the random-access processing unit 502 executes the subsequent random-access process. Note that in a case where a random access response is not received from the base station apparatus, the random-access processing unit 502 retransmits the random access preamble using the radio resource corresponding to the earliest timing after determination, for example. Then, in a case where a connection is not successfully established despite a random access preamble being transmitted a predetermined number of times, the random-access processing unit 502 executes the normal random-access process. In other words, the random-access processing unit 502 selects one of the beams with good wireless quality and transmits the random access preamble generated using a sequence specific to the beam using the radio resource corresponding to the beam.

### Processing Flow

An example of the flow of the processing executed by the base station apparatus will now be described using FIG. 6. Note that the processing of FIG. 6 is merely an example, and the order in which the two or more processing steps are executed may be switched, and one or more of the processing steps may be omitted. Firstly, the base station apparatus determines the radio resources that can be used by the terminal apparatus to transmit a random access preamble for each of the plurality of beams formed by the base station apparatus (S601). Then, the base station apparatus determines a predetermined sequence for generation of a random access preamble that can be commonly used by any of a plurality of the determined radio resources, each of which corresponds to a respective one of the plurality of beams (S602). Also, the base station apparatus determines sequences, each of which can be used only with a respective one of the plurality of radio resources corresponding to each of the plurality of beams (S603). Then, the base station apparatus notifies the terminal apparatus of setting information including the information of the determined radio resource and sequence (S604). Thereafter, the base station apparatus executes a random-access process with the terminal apparatus in response to receiving the random access preamble from the terminal apparatus and establishes a connection (S605). Note that, for example, the base station apparatus may attempt to establish a connection using a beam corresponding to the radio resource used to receive the random access preamble from the terminal apparatus. Also, in a case where a sequence usable with the radio resource of a specific beam is set as the predetermined sequence usable with the radio resource of other beams, the base station apparatus may attempt to establish a connection using the specific beam.

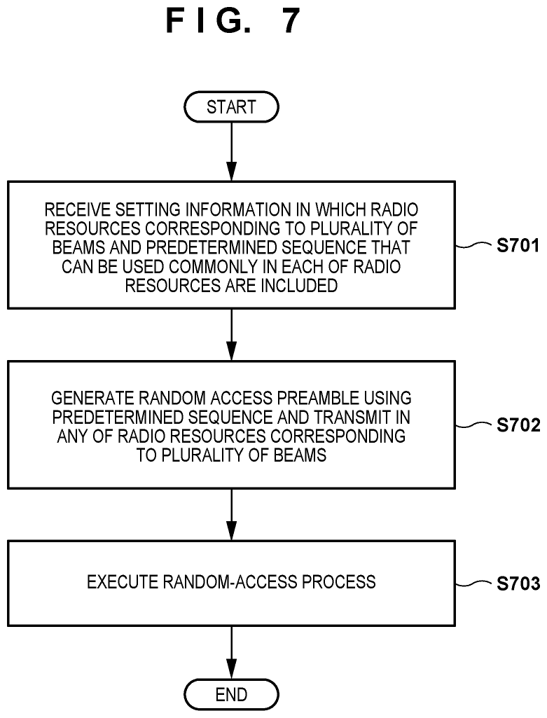

Next, an example of the flow of the processing executed by the terminal apparatus will be described using FIG. 7. Note that the processing of FIG. 7 is merely an example, and the order in which the two or more processing steps are executed may be switched, and one or more of the processing steps may be omitted. First, the terminal apparatus receives the setting information notified by the base station apparatus in S604 described above. In other words, the terminal apparatus receives, from the base station apparatus, setting information including information indicating the radio resources for transmission of the random access preamble corresponding to each of the plurality of beams formed by the base station apparatus and information indicating the predetermined sequence of the random access preamble commonly usable by the radio resources (S701). Note that here, the setting information may include information indicating a sequence individually usable by each of the plurality of radio resources corresponding to the plurality of beams. The terminal apparatus transmits the random access preamble on the basis of the setting information. For example, in a case where a swift connection establishment is requested, the terminal apparatus generates a random access preamble generated using the predetermined sequence described above and transmits it to the base station apparatus using any of the plurality of radio resources corresponding to the plurality of beams (S702). Then, the terminal apparatus executes a random-access process with the base station apparatus (S703). Note that in a case where the terminal apparatus does not successfully execute a random-access process using the predetermined sequence a consecutive predetermined number of times or a swift connection establishment is not required, the terminal apparatus may execute a normal random-access process.

In this manner, the terminal apparatus can establish a swift connection by transmitting a random access preamble using the radio resource corresponding to any of the plurality of beams instead of transmitting a random access preamble using one specific selected beam from among the plurality of beams. This contributes to Goal 9 of the sustainable development goals (SDGs) initiated by the United Nations of “building resilient infrastructure, promoting sustainable industrialization, and foster innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A base station apparatus comprising:
a forming unit configured to form a plurality of beams;
a notifying unit configured to notify a terminal apparatus of information indicating radio resources to be used in transmission of a random access preamble by the terminal apparatus for each of the plurality of beams and information of a predetermined sequence of a random access preamble allowed for transmission using any of the radio resources of the plurality of beams; and
an establishing unit configured to, in a case where a random access preamble generated using the predetermined sequence is detected using the radio resource corresponding to one beam included in the plurality of beams, establish a connection with the terminal apparatus that transmitted the random access preamble.

2. The base station apparatus according to claim 1, wherein a sequence of a random access preamble allowed for transmission using the radio resource corresponding to the beam is set for each of the plurality of beams, and
the predetermined sequence is a sequence of a random access preamble corresponding to a predetermined beam from among the plurality of beams.

3. The base state apparatus according to claim 2, wherein a specific beam from among the plurality of beams which has a smallest sum of distances from a center of an area covered by the specific beam to centers of areas covered by each other beam is selected as the predetermined beam, and
the establishing unit, in a case where a random access preamble generated using the predetermined sequence is detected using the radio resource corresponding to any of the plurality of beams, establishes a connection using the predetermined beam with the terminal apparatus that transmitted the random access preamble.

4. The base station apparatus according to claim 1, wherein
the establishing unit establishes a connection with the terminal apparatus using the one beam.

5. A terminal apparatus comprising:
a receiving unit configured to receive, from a base station apparatus, information indicating radio resources to be used in transmission of a random access preamble by the terminal apparatus for each of a plurality of beams formed by the base station apparatus and information of a predetermined sequence of a random access preamble allowed for transmission using any of the radio resources of the plurality of beams; and
an establishing unit configured to transmit a random access preamble generated using the predetermined sequence using the radio resource corresponding to any of the plurality of beams to attempt to establish a connection with the base station apparatus.

6. The terminal apparatus according to claim 5, wherein a sequence of a random access preamble allowed for transmission using the radio resource corresponding to the beam is set for each of the plurality of beams, and
the predetermined sequence is a sequence of a random access preamble corresponding to a predetermined beam from among the plurality of beams.

7. The terminal apparatus according to claim 5, wherein
a sequence of a random access preamble allowed for transmission using the radio resource corresponding to the beam is set for each of the plurality of beams, and
the establishing unit, in a case where an attempt to establish a connection with the base station apparatus via any of the plurality of beams has failed consecutively a predetermined number of times, selects one beam from among the plurality of beams on a basis of wireless quality of a signal transmitted using each of the plurality of beams, transmits a random access preamble generated using a sequence corresponding to the one beam using the radio resource corresponding to the one beam, and attempts to establish a connection with the base station apparatus.

8. A control method executed by a base station apparatus comprising:
forming a plurality of beams;
notifying a terminal apparatus of information indicating radio resources to be used in transmission of a random access preamble by the terminal apparatus for each of the plurality of beams and information of a predetermined sequence of a random access preamble allowed for transmission using any of the radio resources of the plurality of beams; and
establishing, in a case where a random access preamble generated using the predetermined sequence is detected using the radio resource corresponding to one beam included in the plurality of beams, a connection with the terminal apparatus that transmitted the random access preamble.

9. A control method executed by a terminal apparatus comprising:
receiving, from a base station apparatus, information indicating radio resources to be used in transmission of a random access preamble by the terminal apparatus for each of a plurality of beams formed by the base station apparatus and information of a predetermined sequence of a random access preamble allowed for transmission using any of the radio resources of the plurality of beams; and
transmitting a random access preamble generated using the predetermined sequence using the radio resource corresponding to any of the plurality of beams to attempt to establish a connection with the base station apparatus.

10. A non-transitory computer-readable storage medium that stores a program for causing a computer included in a base station apparatus to:
form a plurality of beams;
notify a terminal apparatus of information indicating radio resources to be used in transmission of a random access preamble by the terminal apparatus for each of the plurality of beams and information of a predetermined sequence of a random access preamble allowed for transmission using any of the radio resources of the plurality of beams; and
establish, in a case where a random access preamble generated using the predetermined sequence is detected using the radio resource corresponding to one beam included in the plurality of beams, a connection with the terminal apparatus that transmitted the random access preamble.

11. A non-transitory computer-readable storage medium that stores a program for causing a terminal apparatus to:
receive, from a base station apparatus, information indicating radio resources to be used in transmission of a random access preamble by the terminal apparatus for each of a plurality of beams formed by the base station apparatus and information of a predetermined sequence of a random access preamble allowed for transmission using any of the radio resources of the plurality of beams; and
transmit a random access preamble generated using the predetermined sequence using the radio resource corresponding to any of the plurality of beams to attempt to establish a connection with the base station apparatus.
